(19) United States
(12) Patent Application Publication
(10) Pub. No.: US 2011/0113978 A1
(43) Pub. Date: May 19, 2011

(54) PRINTING DEVICE FOR A ROTATING PRINTING MACHINE

(75) Inventor: Guenter Koppelkamm, Neuensalz (DE)

(73) Assignee: manroland AG, Offenbach /Main (DE)

(21) Appl. No.: 12/865,717

(22) PCT Filed: Jan. 29, 2009
(86) PCT No.: PCT/EP2009/000571

§ 371 Date: Jul. 30, 2010

(30) Foreign Application Priority Data
Feb. 1, 2008 (DE) 10 2008 007 376.

(51) Int. Cl. B41F 13/10

(52) U.S. Cl. 101/375

(57) ABSTRACT

A printing couple for a rotary printing press is disclosed. The printing couple includes a base and at least one plate cylinder having a pre-determined length, two longitudinal ends rotatably mounted at the base, a radial longitudinal partition, and a peripheral surface facing outward radially in the area of the longitudinal partition and supported radially and rotatably at a bearing unit. The bearing unit includes a rotation bearing having an outer part designed in the shape of a circular segment and is connected to the base. The peripheral surface of the plate cylinder in the area of the longitudinal partition is supported at the inner curvature of the outer part.

This application claims the priority of International Application No. PCT/EP2009/000571, filed Jan. 29, 2009, and German Patent Document No. 10 2008 007 376.8, filed Feb. 1, 2008, the disclosures of which are expressly incorporated by reference herein.

### BACKGROUND AND SUMMARY OF THE INVENTION

The invention relates to a printing couple for a rotary printing press, and in particular to a printing couple having at least one plate cylinder supported along its length in an intermediate section.

Recently, the development trend for rotary printing presses has focused on building wider and wider printing units or printing couples in order to be able to simultaneously print as many pages as possible in these types of printing couples. This increases both the productivity and flexibility of the rotary printing press. The enhanced length dimension of the cylinders of these types of printing couples allows excessive deflection to occur, particularly in the case of slender cylinders, such as for example, single round cylinders. This excessive deflection makes a high-quality printing process impossible, because the cylinder having the increased deflection along its effective length is not able to establish uniform contact with the respective cooperating cylinders.

A printing couple with at least one plate cylinder is known from German Patent Document No. DE 10 2006 011 477 A1, wherein the plate cylinder is configured to be split widthwise into two partial sections and is additionally supported in the area of the split. For the purpose of this additional cylinder support, the printing couple features a crossbar, which is mounted between opposing side frames of the printing couple and which bears the additional cylinder support and to which the cylinder support is fastened. Two adjacent longitudinal ends of the two partial sections, which are arranged in the area of the split, each have a journal, wherein the journal of the one partial section is mounted at the additional cylinder support and the journal of the other partial section is accommodated in the interior of the journal of the one partial section, projects into the other partial section and is connected to the partial section so that it is resistant to torsion, but removable. Two longitudinal ends that face away from each other of the two partial sections also each have a journal, wherein these journals are each mounted in one of the side frames.

However, the disadvantage of the attainment described in this document is that due to the additional cylinder support in the area of the cylinder split, it is not possible to convey a print substrate web that extends over the entire effective length of the plate cylinder to the printing couple for printing, but only partial print substrate webs corresponding to or adapted widthwise to the respective partial sections. The separate partial print substrate webs however experience different print substrate stress in the jointly running printing couple, such as for example, different distortion, which can only be controlled or compensated for with difficulty during operation of the printing couple and may lead to considerable system malfunctions.

The object of the invention is creating a printing couple having at least one plate cylinder supported along its length in an intermediate section, wherein the plate cylinder is supported such that it is possible to process a one-piece print substrate web extending over the entire effective length of the plate cylinder without difficulty in the printing couple.

According to the invention, a printing couple for a rotary printing press comprises a base and at least one plate cylinder having a pre-determined length, two longitudinal ends rotatably mounted at the base, a radial longitudinal partition and a peripheral surface facing outward radially in the area of the longitudinal partition and supported radially and rotatably at a bearing unit, and wherein the bearing unit comprises a rotation bearing having an outer part designed in the shape of a circular segment and being rigidly connected to the base, the peripheral surface of the plate cylinder designed in the area of the longitudinal partition being supported at the inner curvature of the outer part.

Because of the support according to the invention using an outer part designed in the shape of a circular segment, it is possible, on the one hand, to support the plate cylinder precisely in the direction of the bending stress and thereby reduce or avoid a deflection of the plate cylinder. On the other hand, because of the circular segment shape, the plate cylinder is obstructed relatively little in the circumferential direction so that, in terms of installation space, the bearing unit only impacts the other components of the printing couple a little or not at all. As a result, it is also possible to process a one-piece print substrate web extending over the entire effective length of the plate cylinder without difficulty in the printing couple according to the invention.

According to the invention, the pre-determined length of the plate cylinder may correspond, for example, to four to eight print pages arranged side-by-side vertically or horizontally. The format of the print pages for example may be a broadsheet format or a tabloid format. It must be mentioned in this connection that the plate cylinder may also have other length dimensions and the formats of the print pages are not limited to those cited.

What is important according to the invention is only that a plate cylinder of a pre-determined length that tends towards excessive deflection during operation because of its high degree of slenderness is radially supported at a longitudinal partition of the plate cylinder so that the deflection is reduced or avoided. Such a plate cylinder may be a single round plate cylinder for example. In this context “single round” means that the plate cylinder has such a diameter that a single vertical or horizontal print page can be arranged in its circumferential direction.

Of course, with a corresponding length of the plate cylinder, a high degree of slenderness can also be produced with a double round (two print pages in the circumferential direction) or larger plate cylinder so that a radial support of the plate cylinder is required.

According to an embodiment of the invention, the circular-segment-shaped outer part, as viewed in the longitudinal direction of the plate cylinder, has a width that is less than or equal to the width of an area not be printed, which for production-related reasons is to be provided between respectively two print pages arranged side-by-side along the length of the plate cylinder.

In other words, if several print pages, such as for example, vertical or horizontal print pages, are supposed to be arranged side-by-side in a broadsheet format or in a tabloid format along the length of the plate cylinder by means of at least two printing plates, then an area not to be printed extending strip-like around the circumference of the plate cylinder is respectively provided between respectively adjacent print pages or type areas so that a subsequent severing or folding into respectively desired print product pages is possible without difficulty. If the circular-segment-shaped outer part, as viewed in the longitudinal direction of the plate cylinder, has a width that is less than or equal to the area not to be printed, and if the outer part is arranged precisely in such an area, such as for example, in the longitudinal center of the plate cylinder, then no additional waste occurs as a result of the inventive radial support of the plate cylinder.

According to an embodiment of the invention, an outer part contact surface running along the inner curvature is designed on the outer part, the peripheral surface of the plate cylinder designed in the area of the longitudinal partition being supported at the outer part contact surface.

According to another embodiment of the invention, the rotation bearing has an inner part, which is mounted in a rotationally fixed manner on the peripheral surface of the plate cylinder configured in the area of the longitudinal partition and which has an external circumferential inner part contact surface, via which the peripheral surface of the plate cylinder is supported at the outer part.

According to an embodiment of the invention, a plurality of rolling bodies are provided between the outer part contact surface and the inner part contact surface for rolling off along these.

According to an embodiment of the invention, the rolling bodies are formed by circular cylinders.

In other words, according to an embodiment of the invention, the rotation bearing of the bearing unit is designed as a cylinder roller bearing so that an axial adjustment of the plate cylinder and thereby a register adjustment are rendered possible.

According to an embodiment of the invention, a circular segment size of the outer part of the rotation bearing is <180 degrees, in particular <90 degrees. In other words, the circular-segment-shaped outer part of the rotation bearing extends ≦180 degrees, in particular <90 degrees, around the circumference of the plate cylinder.

For this reason, the circular-segment-shaped outer part of the rotation bearing obstructs only a small portion of the circumference of the plate cylinder so that other components of the printing couple according to the invention can be arranged without difficulty and a processing of a one-piece print substrate web extending over the entire effective length of the plate cylinder is possible without difficulty in the printing couple.

According to an embodiment of the invention, the plate cylinder has two plate cylinder parts arranged in succession coaxially with a rotational axis of the plate cylinder and a cylindrical connecting element, which is arranged coaxially with the rotational axis between the two plate cylinder parts in the area of the longitudinal partition of the plate cylinder and which rigidly connects the two plate cylinder parts with each other.

This embodiment advantageously supports the manufacturing of especially long plate cylinders such as for example, those for printing couples wide enough for eight print pages. The two plate cylinder parts are preferably equally long so that for example, in the case of a printing couple wide enough for eight print pages, each plate cylinder part would have a length corresponding to four print pages arranged side-by-side. It is still possible to process this cylinder length without difficulty in standard processing machinery, whereas a cylinder length corresponding to eight print pages arranged side-by-side would be problematic in terms of both standard processing machinery as well as transport.

According to one embodiment of the invention, the peripheral surface of the plate cylinder designed in the area of the longitudinal partition is formed by the circumference of the connecting element.

In other words, according to an embodiment of the invention, the inner part of the rotation bearing is mounted in a rotationally fixed manner on the peripheral surface of the connecting element.

This embodiment of the invention makes it possible in an advantageous way to source the bearing unit according to the invention modularly as a vendor part. As a result, the vertical range of manufacture can be reduced, on the one hand, thereby saving costs, and the manufacturing-related expertise of manufacturers focused especially on manufacturing bearings can be used, on the other hand.

According to another embodiment of the invention, however, it is also possible for the inner part contact surface of the rotation bearing to be formed directly by the peripheral surface of the connecting element.

According to an embodiment of the invention, the connecting element has two longitudinal ends, each of which is formed in a short conical shape, wherein the two plate cylinder parts have two adjacent longitudinal ends, in which respectively a recess that is complementary to the short conical shape of the longitudinal ends of the connecting element is formed coaxially with the rotational axis, and wherein the longitudinal ends of the connecting element each fit into one of the recesses so that the two plate cylinder parts are connected to one another so they are disassembly-proof.

This embodiment of the invention allows a stable, precise and extraordinarily rigid connection of the plate cylinder parts to be achieved in a simple manner that is favorable in terms of manufacturing. The two short conical fits guarantee in particular a precise centering of the two cylinders on a common longitudinal center axis so that the plate cylinder is able to reliably fulfill the requirements placed on its concentricity.

According to an embodiment of the invention, an end recess in a short conical shape designed coaxially with the rotational axis is provided respectively in two longitudinal ends facing away from each other of the two plate cylinder parts, wherein the plate cylinder has two cylindrical journal elements, each of which has a longitudinal end, which has a shape that is complementary to the short conical shape of the end recesses, wherein one of the journal elements is fit with its longitudinal end designed in a short conical shape into each end recess so it is disassembly-proof, and wherein the journal elements each have a second longitudinal end, which is rotatably mounted at the base.

This embodiment of the invention makes it possible for both plate cylinder parts to be designed identically so that the manufacturing costs may be greatly reduced. Because the plate cylinder parts each have recesses with a short conical form on their longitudinal ends, the plate cylinder parts can be tensioned reliably and precisely during their manufacturing.

Furthermore, the journal elements may again be sourced modularly as a vendor part. As a result, the vertical range of manufacture can be reduced further and additional costs can be saved.

According to an embodiment of the invention, the plate cylinder is designed as a forme cylinder.

According to another embodiment of the invention, the printing couple has at least one other cylinder, which is set up to cooperate with the plate cylinder and which has an axis with two longitudinal ends, which are mounted at the base, wherein the bearing unit has a connector, which connects the outer part of the rotation bearing to the base, and wherein the bearing unit has at least one other bearing, which is arranged at the connector, for the radial support of the axis of the at least one other cylinder.

As a result, the bearing unit according to the invention makes it possible to radially support additional cylinders of the printing couple that tend to deflect in the case of a radial load because of the slenderness of their respective axes thereby reliably reducing or avoiding a deflection of the axes.

According to an embodiment of the invention, the axis of the at least one other cylinder is moveable into a first position, in which the axis is supported radially at the connector via the other bearing and the cylinder cooperates with the plate cylinder, and is moveable into a second position, in which the cylinder does not cooperate with the plate cylinder.

This embodiment advantageously guarantees, on the one hand, that the axis of the at least one other cylinder is radially supported when the printing couple is in operation, and, on the other hand, that this cylinder can be swiveled away from the plate cylinder during set-up procedures or maintenance work or other kinds of processes, wherein the axis of the at least one other cylinder may remain in the bearing in the connector or may be swiveled out of it.

According to an embodiment of the invention, provided in the connector is a passage opening, in which the at least one other bearing is provided, and wherein the axis of the at least one other cylinder extends through the passage opening in its first position.

The passage opening may be designed for example as a slot in the connector that is open on one end so that the axis may be swiveled into the slot (e.g., first position) and swiveled out of the slot (e.g., second position). The embodiment with an open slot is especially favorable in terms of mounting the axis, because it can be inserted into the bearing in the slot in a simple manner.

Of course, it is also possible to configure the passage opening as an oblong hole for example. In this case, however, the axis would have to be threaded longitudinally into the oblong hole or be designed in a split manner or an opening possibility would have to be provided on the oblong hole for inserting the axis.

According to one embodiment of the invention, the at least one other cylinder is designed as an ink application roller or as a dampening application roller.

The invention will be described in greater detail in the following on the basis of preferred embodiments and making reference to the enclosed figures.

### BRIEF DESCRIPTION OF THE DRAWINGS

FIG. 1 shows a schematic side view of a printing unit, which is equipped with several printing couples according to a first embodiment of the invention.

FIG. 2 shows a schematic top view of a plate cylinder of a printing couple according to the first embodiment of the invention.

FIG. 3 shows a view similar to FIG. 2, wherein possible slitting guides are shown on a print substrate web printed in the printing couple according to the first embodiment of the invention.

FIG. 4 shows an enlarged schematic view of the printing couple according to the first embodiment of the invention and its radial support.

FIG. 5 shows an enlarged detailed view of an area Z identified in FIGS. 2 and 3 in a first slitting plane of the plate cylinder.

FIG. 6 shows an enlarged detailed view of the area Z identified in FIGS. 2 and 3 in a second slitting plane of the plate cylinder.

### DETAILED DESCRIPTION OF THE DRAWINGS

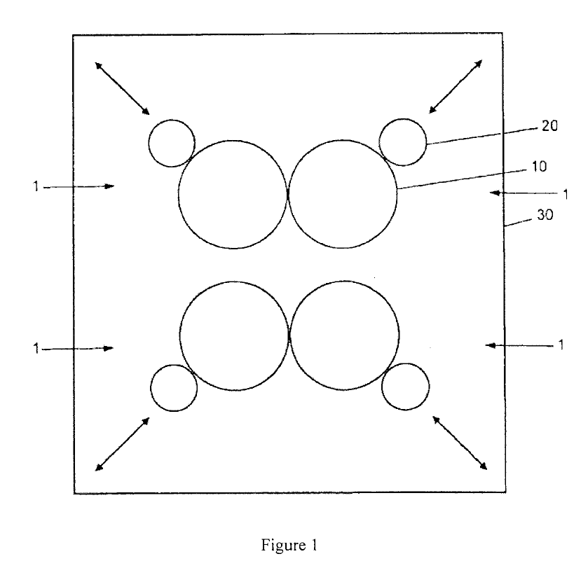

Now a first embodiment of a printing couple according to the invention for a rotary printing press will be described making reference to FIGS. 1 to 6.

FIG. 1 shows a schematic side view of a printing unit for a rotary printing press, which is equipped with four printing couples 1. The printing couples 1 each have a transfer cylinder 10 designed in the form of a blanket cylinder and a plate cylinder 20 designed in the form of a forme cylinder.

The other components of the respective printing couples 1 such as for example, an inking unit and a dampening unit are omitted from FIG. 1 for the sake of clarity. The printing unit also has a base 30 on which the transfer cylinders 10 and the plate cylinders 20 are mounted or supported.

The plate cylinder 20 according to this embodiment is designed to be single round, whereas the transfer cylinder 10 is designed to be triple round. Naturally, it is also conceivable for example, to pair the single round plate cylinder 20 with a double round transfer cylinder 10.

The double arrows in FIG. 1 provided on the respective printing couples 1 indicate the respective radial supports of the plate cylinders 20 at the base 30.

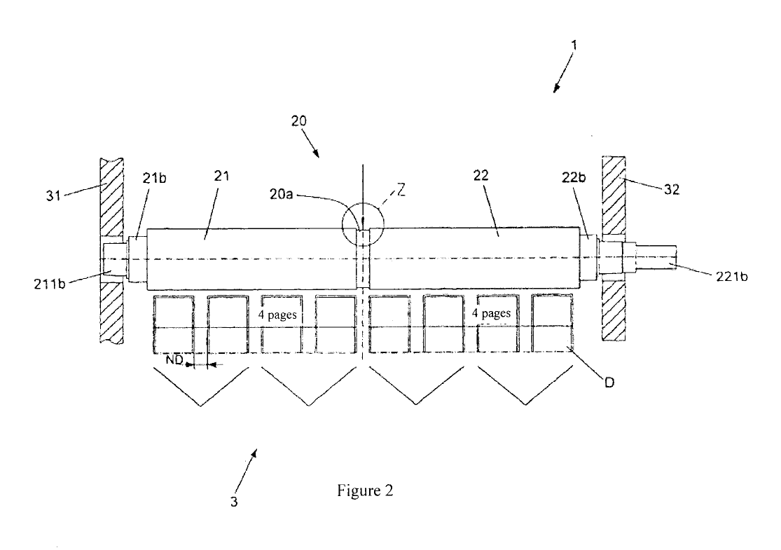

For the sake of clarity, only the components of a printing couple 1 according to the invention that are relevant in this case to describe the invention are depicted in FIGS. 2 to 6 and are described in the following.

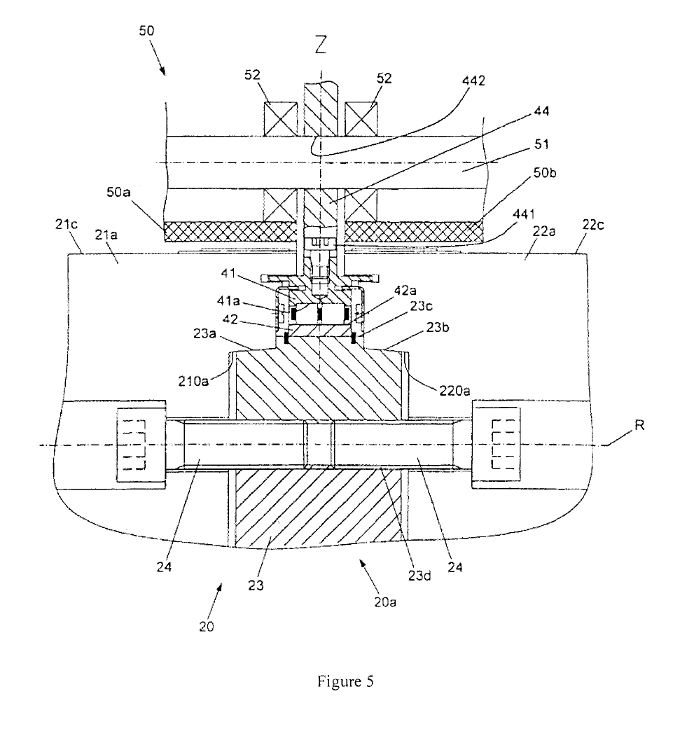

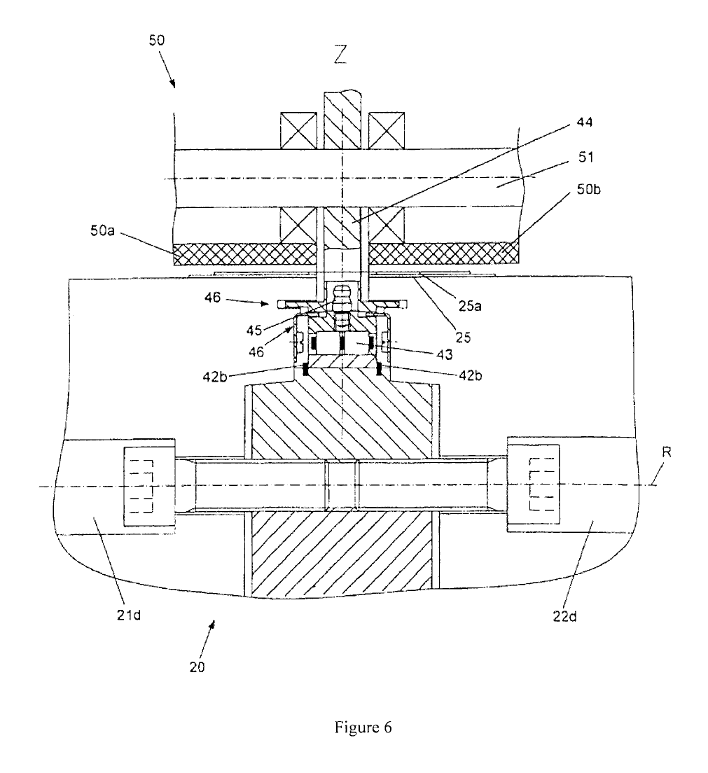

The plate cylinder 20 according to this embodiment (see FIGS. 5 and 6 in particular) has a first plate cylinder part 21 and a second plate cylinder part 22, which are arranged in succession coaxially with a rotational axis R of the plate cylinder 20, and a cylindrical connecting element 23, which is arranged coaxially with the rotational axis R between the two plate cylinder parts 21, 22 in the area of a radial longitudinal partition 20a of the plate cylinder 20 and which connects the two plate cylinder parts 21, 22 rigidly to each other.

The connecting element 23 has a first longitudinal end 23a and a second longitudinal end 23b, each of which are designed in a short conical shape, a peripheral surface 23c, and a through-thread borehole 23d, which extends coaxially with the rotational axis R of the plate cylinder.

The two plate cylinder parts 21, 22 have two adjacent first longitudinal ends 21a and 22a, in each of which a recess 210a or 220a that is complementary to the short conical shape of the two longitudinal ends 23a, 23b of the connecting element 23 is formed coaxially with the rotational axis R.

A continuous deep-hole bore 21d or 22d is formed in each of the two plate cylinder parts 21, 22, which bore runs respectively coaxially with the rotational axis R of the plate cylinder 20 and which is stepped in the area of the respective first longitudinal end 21a or 22a reducing its diameter.

The short-conical-shaped first longitudinal end 23a of the connecting element 23 is fit into the short-conical-shaped recess 210a of the first longitudinal end 21a of the first plate cylinder part 21. The short-conical-shaped second longitudinal end 23b of the connecting element 23 is fit into the short-conical-shaped recess 220a of the first longitudinal end 22a of the second plate cylinder part 22.

A respective connecting screw 24 is inserted into the deep-hole bores 21d and 22d of the first and of the second plate cylinder part 21, 22 and screwed into the through-thread borehole 23d of the connecting element 23 so that the two plate cylinder parts 21, 22 are connected to each other rigidly and so that they are disassembly-proof.

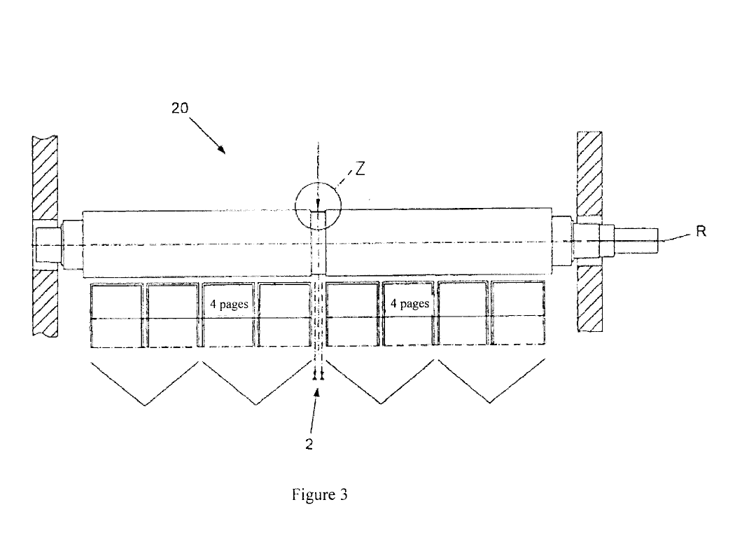

The thusly assembled plate cylinder 20 according to this embodiment (see FIGS. 2 and 3 in particular) has such a length that eight vertical print pages D may be arranged side-by-side in broadsheet format along its length, wherein a distance ND is respectively present between adjacent print pages D as an area that is not to be printed.

Furthermore, the two plate cylinder parts 21, 22 have two second longitudinal ends 21b and 22b facing away from each other, on which journals 211b or 221b are configured, which are respectively rotatably mounted in side frames 31 or 32 of the base 30.

As FIGS. 2 and 3 also show, the rotary printing press has a slitter 2 (see FIG. 3) for slitting a print substrate web printed in the printing unit or the printing couples 1 along with a former arrangement 3 for longitudinally folding the slit print substrate web.

It becomes evident from the design of the plate cylinder 20 described above that the plate cylinder would be susceptible to a radial deflection when the printing couple 1 is in operation, because of its great length dimension in conjunction with its relatively small diameter (based on the single round design).

However, the printing couple 1 according to the invention features a support (see the double arrows in FIG. 1) acting radially from the outside on the plate cylinder 20 in the area of the longitudinal partition, which prevents or reduces a deflection of the plate cylinder.

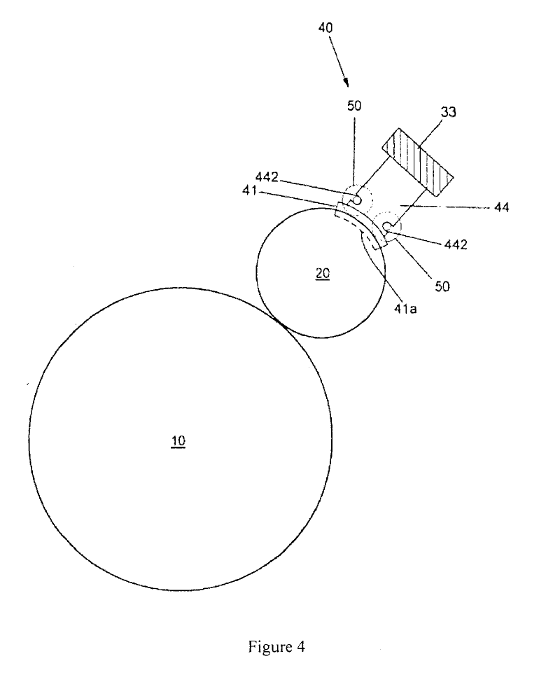

To this end, the printing couple 1 has a bearing unit 40, which is supported stably on a crossbar 33 of the base 30 extending between the side frames 31, 32 (see FIG. 4).

The bearing unit 40 has an outer part 41 designed in the shape of a circular segment, an inner part 42, circular cylindrical rolling bodies 43 as well as a connector 44.

The connector 44 is stably connected to the crossbar 33 with a longitudinal end by means of screwed connections (not shown) and is supported thereon. The outer part 41 is attached to the other longitudinal end of the connector 44 by means of connecting screws 441.

The inner part 42 is rotatably mounted on the radially outwardly facing peripheral surface 23c of the connecting element 23 of the plate cylinder 20 and secured against axial displacement by means of retaining rings 42b.

The inner part 42 has an inner part contact surface 42a and the circular-segment-shaped outer part 41 has an outer part contact surface 41a on its inner curvature, wherein several of the rolling bodies 43 are arranged between the inner part contact surface 42a and the outer part contact surface 41a and can roll off these.

The outer part contact surface 41a is designed so that the rolling bodies roll off in a groove and thereby secure the outer part 41 against axial displacement. The inner part contact surface 42a is designed as a smooth ungrooved surface so that the plate cylinder 20 or the inner part 42 is axially displaceable in relation to the rolling bodies 43 or the outer part 41 for register adjustment of the printing couple 1.

Hence, the outer part 41, inner part 42 and rolling bodies 43 form a rotation bearing of the bearing unit 40, via which the plate cylinder 20 is supported radially from the outside and rotatably at the crossbar 33 of the base 30 in the area of its longitudinal partition 20a.

To lubricate the rotation bearing of the bearing unit 40 supporting the plate cylinder 20, at least one grease nipple 45 is provided on the outer part 41, via which the lubricant such as for example, bearing grease, can be introduced to the rolling bodies 43 and the contact surfaces 41a, 42a (see FIG. 6).

Seals 46 are provided on the rotation bearing to seal the rotation bearing of the bearing unit 40 supporting the plate cylinder 20 against the escape of lubricant (see FIG. 6).

As FIG. 4 shows particularly well, the outer part 41 has a circular segment size of less than 90 degrees, whereby the outer part 41 requires only a little space along the circumference of the plate cylinder 20 and nevertheless supports the plate cylinder 20 securely against radial deflection in the direction of deflection (corresponding to the double arrows in FIG. 1). Thus, the rotation bearing of the bearing unit 40 obstructs only a small portion of the circumference of the plate cylinder 20 so that other components of the printing couple 1 according to the invention can be arranged without difficulty and a processing of a one-piece print substrate web extending over the entire effective length of the plate cylinder 20 is possible without difficulty in the printing couple 1.

The outer part 41 of the bearing unit 40, as viewed in the longitudinal direction of the plate cylinder 20, also has a width that is less than or equal to the width of the area not to be printed ND (see FIG. 2), which for production-related reasons is to be provided between respectively two print pages D arranged side-by-side along the length of the plate cylinder 20.

As FIG. 6 shows particularly well, the plate cylinder 20 is equipped or may be equipped with several printing plates 25 along its length to produce the printed images D, wherein each printing plate 25 has a type area 25a, which delimits the printed image of the associated printing plate 25. Thus, there is an area not to be printed ND located between the printed images D in the area of the longitudinal partition 20a of the plate cylinder 20 and thus in the area of the rotation bearing of the bearing unit 40, in which not-to-be-printed area a print substrate web printed by the printing couple 1 is subsequently slit.

Hence, no additional waste is caused by supporting the plate cylinder 20 by means of the bearing unit 40 according to the invention.

Referring in particular to FIGS. 4, 5 and 6, the printing couple 1 has at least one other cylinder 50, which is set up to cooperate with the plate cylinder 20 and which has an axis 51 with two longitudinal ends, which are rotatably mounted in the side frames 31, 32 of the base 30.

Provided in the connector 44 of the bearing unit 40 is at least one passage opening 442 designed as an oblong hole open on a longitudinal side, which form a bearing for the radial support of the axis 51 of the at least one other cylinder 50.

As FIG. 5 and FIG. 6 show, the cylinder 50 is realized as a hollow cylinder configured with two cylinder parts 50a and 50b, wherein the cylinder parts 50a, 50b have a distance corresponding to area ND in the area of their partition and are rotatably mounted on the axis 51 via rotation bearings 52.

The axis 51 of the cylinder 50 can be swiveled into a first position, in which it extends parallel to the plate cylinder 20 through the passage opening 442 of the connector 44 and is supported radially in the passage opening 442, wherein the cylinder 50 cooperates with the plate cylinder 20 or is in physical contact. The axis 51 of the cylinder 50 can also be swiveled out of the passage opening 442 into a second position, in which the cylinder 50 does not cooperate with the plate cylinder 20 or is not in physical contact with the plate cylinder.

As FIG. 4 shows, according to this embodiment the printing couple 1 has two such additional cylinders 50 in the form of an ink application roller or a dampening application roller. Accordingly, two passage openings 442 are provided in the connector 44 for positioning the respective axes 51 of the two cylinders 50.

Thus, in the case of the printing couple 1 according to the invention, additional cylinders 50 that are at risk of deflection because of their degree of slenderness may also be securely supported radially thereby reducing or avoiding a deflection of the cylinders.

A second embodiment of the printing couple 1 according to the invention will be described in the following, which is identical to the first embodiment of the printing couple 1 according to the invention except for the differences described in the following but not depicted in the figures.

According to the second embodiment of the printing couple 1, a respective end recess in a short conical shape designed coaxially with the rotational axis R of the plate cylinder 20 is also provided in the two opposing longitudinal ends 21b, 22b of the two plate cylinder parts 21, 22 of the plate cylinder 20.

Instead of the journals 211b, 221b solidly formed on the plate cylinder parts 21, 22, the plate cylinder 20 has two cylindrical journal elements, each of which has a longitudinal end, which has a shape that is complementary to the short conical shape of the end recesses. One of the journal elements is fit with its longitudinal end designed in a short conical shape into each of the end recesses so that it is disassembly-proof, wherein the journal elements each have a second longitudinal end, which is rotatably mounted in one of the side frames 31, 32 of the base 30.

For the purpose of mounting the journal elements on the respective plate cylinder parts 21, 22 so they are disassembly-proof, the journal elements each have an annular collar covering the end recesses, in which through holes are provided, which correspond to threaded holes in the surfaces of the longitudinal ends 21b or 22b of the plate cylinder parts 21, 22 that face the side frames 31 or 32 and in which connecting screws are inserted and screwed into the threaded holes, thereby holding the respective journal elements in the end recesses so they are disassembly-proof.

### LIST OF REFERENCE NUMBERS

1 Printing couple
10 Transfer cylinder
20 Plate cylinder
20a Longitudinal partition of the plate cylinder
21 First plate cylinder part
21a First longitudinal end of the first plate cylinder part
210a Short-conical-shaped recess of the first plate cylinder part
21b Second longitudinal end of the first plate cylinder part
211b Journal of the first plate cylinder part
21c Peripheral surface of the first plate cylinder part
21d Deep-hole bore of the first plate cylinder part
22 Second plate cylinder part
22a First longitudinal end of the second plate cylinder part
220a Short-conical-shaped recess of the second plate cylinder part
22b Second longitudinal end of the second plate cylinder part
221b Journal of the second plate cylinder part
22c Peripheral surface of the second plate cylinder part
22d Deep-hole bores of the second plate cylinder part
23 Connecting element
23a First longitudinal end of the connecting element
23b Second longitudinal end of the connecting element
23c Peripheral surface of the connecting element
24 Connecting screw(s)
25 Printing plate(s)
25a Type area
30 Base
31 Side frame
32 Side frame
33 Crossbar
40 Bearing unit
41 Outer part
41a Outer part contact surface
42 Inner part
42a Inner part contact surface
42b Retaining ring(s)
43 Rolling body
44 Connector
441 Connecting screw(s)
442 Passage opening
45 Grease nipple
46 Seal(s)
50 Cylinder (ink application roller, dampening application roller)
50a First cylinder part
50b Second cylinder part
51 Axis
52 Rotation bearing
2 Slitter
3 Former arrangement
D Print page(s)
R Rotational axis
ND Area not to be printed

1.-16. (canceled)

17. A printing couple for a rotary printing press, comprising:
a base;
a plate cylinder having a pre-determined length, two longitudinal ends rotatably mounted at the base, a radial longitudinal partition, and a peripheral surface facing outward radially in an area of the longitudinal partition; and
a bearing unit connected to the base, wherein the plate cylinder is supported radially and rotatably at the bearing unit, and wherein the bearing unit comprises a rotation bearing having an outer part designed in a shape of a circular segment, and further wherein the peripheral surface of the plate cylinder designed in the area of the longitudinal partition is supported at an inner curvature of the outer part.

18. The printing couple according to claim 17, wherein the outer part of the bearing unit, as viewed in a longitudinal direction of the plate cylinder, has a width that is less than or equal to a width of an area not to be printed which is provided between respectively two print pages arranged side-by-side along the length of the plate cylinder.

19. The printing couple according to claim 17, wherein an outer part contact surface running along the inner curvature is provided on the outer part, and wherein the peripheral surface of the plate cylinder in the area of the longitudinal partition is supported at the outer part contact surface.

20. The printing couple according to claim 19, wherein the rotation bearing has an inner part which is mounted in a rotationally fixed manner on the peripheral surface of the plate cylinder in the area of longitudinal partition and which has an external circumferential inner part contact surface via which the peripheral surface of the plate cylinder in the area of the longitudinal partition is supported at the outer part.

21. The printing couple according to claim 20, wherein a plurality of rolling bodies are provided between the outer part contact surface and the inner part contact surface.

22. The printing couple according to claim 21, wherein the rolling bodies are formed by circular cylinders.

23. The printing couple according to claim 17, wherein a circular segment size of the outer part of the rotation bearing is ≦180 degrees.

24. The printing couple according to claim 17, wherein the plate cylinder has two plate cylinder parts arranged in succession coaxially with a rotational axis of the plate cylinder and a cylindrical connecting element which is arranged coaxially with the rotational axis between the two plate cylinder parts in the area of longitudinal partition of the plate cylinder and which connecting element rigidly connects the two plate cylinder parts.

25. The printing couple according to claim 24, wherein the peripheral surface of the plate cylinder in the area of longitudinal partition is formed by a circumference of the connecting element.

26. The printing couple according to claim 24, wherein the connecting element has two longitudinal ends formed in a short conical shape, wherein the two plate cylinder parts have two adjacent longitudinal ends in which respectively a recess that is complementary to the short conical shape of the longitudinal ends of the connecting element is formed, and wherein the longitudinal ends of the connecting element each fit into one of the recesses so that the two plate cylinder parts are connected to one another.

27. The printing couple according to claim 26, wherein an end recess in a short conical shape designed coaxially with the rotational axis is provided respectively in two longitudinal ends facing away from each other of the two plate cylinder parts, wherein the plate cylinder has two cylindrical journal elements, each of which has a longitudinal end which has a shape that is complementary to the short conical shape of the end recesses, wherein one of the journal elements is fit with its longitudinal end designed in a short conical shape into each of the end recesses, and wherein the journal elements each have a second longitudinal end which is rotatably mounted at the base.

28. The printing couple according to claim 17, wherein the plate cylinder is a forme cylinder.

29. The printing couple according to claim 28, further comprising a cylinder which cooperates with the plate cylinder and which has an axis with two longitudinal ends which are mounted at the base, wherein the bearing unit has a connector which connects the outer part of the rotation bearing to the base, and wherein the bearing unit has a bearing which is arranged at the connector and radially supports the axis of the cylinder.

30. The printing couple according to claim 29, wherein the axis of the cylinder is moveable into a first position in which the axis is supported radially at the connector via the bearing and the cylinder cooperates with the plate cylinder, and wherein the axis of the cylinder is moveable into a second position in which the cylinder does not cooperate with the plate cylinder.

31. The printing couple according to claim 30, wherein the connector includes a passage opening in which the bearing is provided, and wherein the axis of the cylinder extends through the passage opening in the first position.

32. The printing couple according to claim 29, wherein the cylinder is an ink application roller or a dampening application roller.
